(19) United States
(12) Patent Application Publication
(10) Pub. No.: US 2026/0116310 A1
(43) Pub. Date: Apr. 30, 2026

(54) MOVABLE VEHICLE CONSOLE WITH ROBOTIC ARM

(71) Applicant: FCA US LLC, Auburn Hills, MI (US)

(72) Inventors: Mark E Stout, Auburn Hills, MI (US); Travis D Bechtel, Auburn Hills, MI (US)

(21) Appl. No.: 18/932,719

(22) Filed: Oct. 31, 2024

(51) Int. Cl. B60R 11/00; B25J 18/02; B25J 19/02

(52) U.S. Cl. CPC B60R 11/00; B25J 18/02; B25J 19/023; B60R 2011/0007

(57) ABSTRACT

A vehicle includes a passenger compartment, a console, and an arm carried by the console. The passenger compartment has seats in multiple rows and the console is located in the passenger compartment. At least part of the console is a movable portion that is movable from a first position in which the movable portion is received between two seats in a front row and a second position in which the movable portion is spaced in the fore-aft direction from the two seats in the front row. The arm is carried by the console for movement with the console, and at least part of the arm is movable relative to the console to permit an end of the arm to be positioned in different locations relative to the console.

### FIELD

The present disclosure relates to a vehicle with a movable console and a robotic arm.

### BACKGROUND

Many vehicles include seats arranged in more than one row, with the rows spaced apart within an interior of the vehicle. Conveying items from a passenger in one row of seats to a passenger in another row of seats can be difficult, and may be distractive to vehicle operation if attempted by a driver of the vehicle. In vehicles having three rows of seats, passing items from the front row to a back row can be difficult, as can retrieving items from different areas of the vehicle interior. Communication between passengers in different rows of seats also can be difficult and distracting. Further, storage within the interior of the vehicle is limited and not secure.

### SUMMARY

In at least some implementations, a vehicle includes a passenger compartment, a console, and an arm carried by the console. The passenger compartment has two seats in a front row, the two seats in the front row being spaced apart in a cross-car direction extending between a left side and a right side of the vehicle, and multiple seats in one or more rows spaced from the front row in a fore-aft direction extending between a front and a rear of the vehicle. The console is located in the passenger compartment, at least part of the console is a movable portion that is movable from a first position in which the movable portion is received between the two seats in the front row and a second position in which the movable portion is spaced in the fore-aft direction from the two seats in the front row. The arm is carried by the console for movement with the console, and at least part of the arm is movable relative to the console to permit an end of the arm to be positioned in different locations relative to the console.

In at least some implementations, one or more actuators are carried by the console and coupled to the arm to move the arm relative to the console.

In at least some implementations, the arm includes an end effector that includes one or more of a video device, a display, an audio device, a proximity sensor, a distance sensor, a light, a vison sensor, a tool attachment, and a gripper. In at least some implementations, the end effector includes a first video device and images captured by the first video device are sent to a second video device that is arranged for use by a passenger in the front row. In at least some implementations, a control system is communicated with the console and the arm, and the end effector includes a first video device communicated with the control system for wireless transmission from the vehicle.

In at least some implementations, the arm is defined by multiple segments with a separate joint connecting each segment of the multiple segments to an adjacent segment of the multiple segments, and the joints permit movement of the segments relative to each other and relative to the console.

In at least some implementations, the arm includes an end effector that is provided on a free end of an end segment of the multiple segments, and the end segment is connected to a different segment of the multiple segments at a location spaced from the free end, and the end effector is movable relative to the console about three axes.

In at least some implementations, the end effector includes a camera and the arm is extendable to move the camera away from the console and toward a seat that is not within the front row and which is at least partially offset in the cross-car direction from the console.

In at least some implementations, the end effector includes a gripper and the arm is movable to a position in which the gripper can grab an item off of the console or place an item on the console.

In at least some implementations, the end effector includes a gripper and the vehicle includes a vacuum and the arm is capable of moving the gripper into engagement with an end of a vacuum hose so that the arm can move the end of the vacuum hose within the passenger compartment to vacuum part of the passenger compartment.

In at least some implementations, the arm is connected to the console at a first end of a first segment of the multiple segments, and the arm has a free end at an end of a different segment of the multiple segments and an end effector is provided at the free end to permit the end effector to be moved relative to the console. In at least some implementations, the first end is connected to a surface of the console and the surface includes a periphery defined by edges of the surface, and the arm has a first position in which the arm does not extend outwardly of the periphery of the surface. In at least some implementations, the surface is a rear surface of the console that has opposite side edges that extend in a vertical direction, and opposite upper and lower edges that extend in the cross-car direction, and when the arm is in the first position of the arm the arm does not extend in the cross-car direction beyond the side edges and the arm does not extend in the vertical direction beyond the upper edge or lower edge.

In at least some implementations, a control system is communicated with the console and the actuator, the control system including a communication device by which instructions for control of the arm can be wirelessly received and communicated with the control system to activate the actuator and control the arm in accordance with the instructions.

In at least some implementations, a track is located in the passenger compartment and extends in the fore-aft direction, and the movable portion of the console is connected to the track and moves in the fore-aft direction along the track.

In at least some implementations, the one or more rows includes a second row of seats that has two seats that are spaced apart in the cross-car direction, and the movable portion of the console is movable to a location in which the movable portion overlaps the seats in the second row in the fore-aft direction. In at least some implementations, the one or more rows includes a third row of seats that has one or more seats spaced in the fore-aft direction from the seats of the second row, and when the movable portion of the console is in the second position, the arm is located to be able to be moved within a space between the second row and the third row.

In at least some implementations, at least one seat is movable from a first position to a second position and the arm is operable to engage and move the at least one seat from the first position to the second position.

In at least some implementations, at least one seat includes an area between a seat bottom and a floor of the passenger compartment, and part of the arm is movable into the area between the seat bottom and the floor.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 is a perspective view of a vehicle;

FIG. 2 is an overhead view of part of the vehicle showing one or more storage containers in a cargo compartment;

FIG. 3 is a side view of part of the vehicle as in FIG. 2;

FIG. 4 is an overhead view of part of the vehicle showing one or more storage containers in a passenger compartment;

FIG. 5 is a side view of part of the vehicle as in FIG. 4;

FIG. 6 is an overhead view of part of the vehicle showing a console in a second position within the passenger compartment;

FIG. 7 is a side view of the part of the vehicle as in FIG. 6;

FIG. 8 is an overhead view of part of the vehicle showing the console in a third position within the passenger compartment;

FIG. 9 is a perspective view of a console including a robotic arm and arranged near a first row 42 of seats in a first position;

FIG. 10 is a perspective view showing the console in a second position and with the robotic arm extended away from the console and including video and audio interface devices;

FIG. 11 is a perspective view showing the robotic arm extended laterally between rows of seats and including an end effector configured as a gripper;

FIG. 12 is a perspective view showing the console in a third position adjacent to a second or middle row of seats and with the robotic arm extended toward a third row of seats;

FIG. 13 is a perspective view showing the robotic arm manipulating a vacuum hose to clean an area of the vehicle interior; and

FIG. 14 is a schematic view of components of the vehicle including a control system.

### DETAILED DESCRIPTION

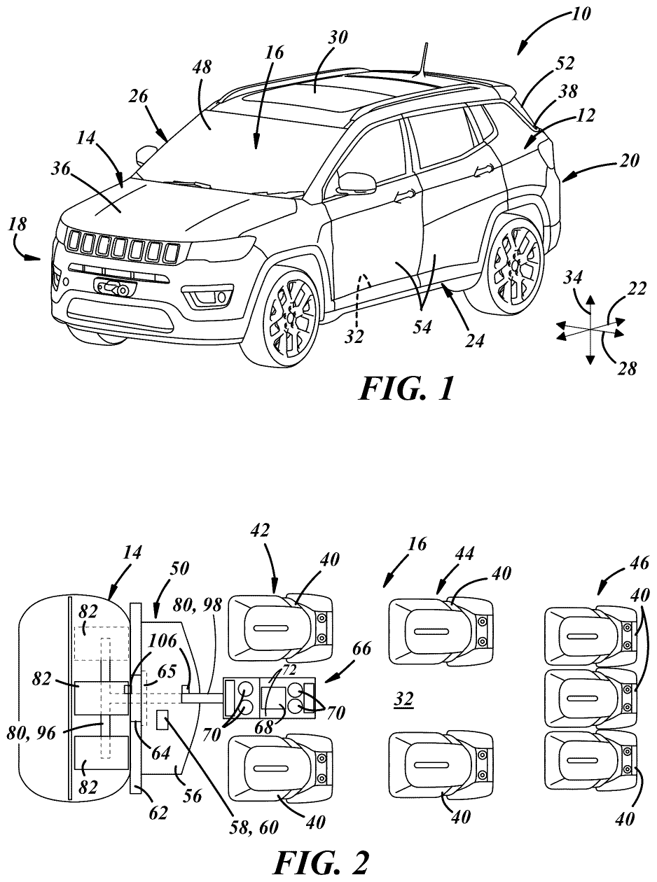

Referring in more detail to the drawings, FIG. 1 shows a vehicle 10 that includes a vehicle body 12 having a cargo compartment 14 and a passenger compartment 16 (sometimes called a cabin, and which may include one or more cargo areas). The vehicle includes one or both of a movable storage container and a movable console that provide flexible storage options usable by more occupants of the vehicle and enabling greater storage space and access to the storage space.

The vehicle 10 includes a front end 18 and a rear end 20 that are spaced apart in a fore-aft direction (shown by arrow 22), left and right sides 24, 26 that are spaced apart in a cross-car direction (shown by arrow 28), and a roof 30 and floor 32 that are spaced apart in a vertical direction (shown by arrow 34). The cargo compartment 14 may be separate from the passenger compartment 16 and typically is provided at one or both of the rear of the vehicle 10 (often called a trunk) and the front of the vehicle 10 (often called a front compartment 14 or frunk). A vehicle deck lid, such as a hood 36 or trunk lid/tailgaite 38 may define part of the cargo compartment 14 which may be separate from or contiguous/open to the passenger compartment 16, in at least some implementations. The deck lid is movable from a closed position to an open position to permit access to the area beneath the deck lid, which may include the cargo compartment 14. While not limited to electric vehicles, certain electric vehicles have considerable space available in the front compartment 14 or frunk and may be readily adapted for storage as noted herein.

Referring to FIGS. 2-5, the passenger compartment 16 is part or all of a vehicle interior and includes seats 40 for vehicle 10 occupants. In the example shown, a front row 42 of seats 40 includes two seats, e.g. for a driver and front passenger, a second row 44 with two seats 40 spaced apart in the cross-car direction, and a third row 46 having three seats 40. Any desired seating configuration may be used. The passenger compartment 16 may be defined at least in part by the roof 30 (e.g. interior headliner), floor 32, a windshield 48 (FIG. 1) and an instrument panel 50 at a front of the passenger compartment 16, a rear window 52 (FIG. 1) and/or body panel at a rear of the passenger compartment 16, and one or more doors 54 (FIG. 1) at the left and right sides 24, 26 of the vehicle 10, and associated vehicle structural components, such as pillars that extend to and are coupled to the roof.

The instrument panel 50 includes one or more interior trim pieces 56 and one or more displays 58 on which vehicle operational information is provided (e.g. gauges for speed, engine temperature and engine rpms, and icons for warning messages, etc.) and via which a human-machine interface (HMI) 60 may be provided. The HMI 60 may be part of an infotainment system 61 by which various vehicle controls may be implemented or selected by a user, such as by a touch screen or other inputs like buttons or dials, and by which a remote device may be connected (e.g. a smart phone) and audio (e.g. radio/sound system) and other devices or systems may be accessed for user control. On or near the instrument panel 50, one or more drive controls may be provided, such as a steering input/wheel, a transmission/powertrain gear selector, an accelerator input and a brake input. The instrument panel 50 may define or be connected to a divider 62 that spans in the cross-car direction between the left and right sides 24, 26, in the vertical direction from the floor 32 to the windshield 48, and is located in the fore-aft direction between the cargo compartment 14 and the passenger compartment 16. The divider 62 may be, in at least some implementations, a structural member of the vehicle 10, sometimes called a firewall and may be used to separate powertrain components in the front compartment 14 from the passenger compartment 16 and to mount or passthrough various vehicle 10 components within the front compartment 14. The divider 62 may define at least part of the passenger compartment 16, in at least some implementations.

To permit at least selective communication between the cargo compartment 14 and the passenger compartment 16, an opening 64 is provided in the divider 62. The opening 64 may be located below the instrument panel 50 or through part of the instrument panel 50. In at least some implementations, a cover 65 is provided that is movable relative to the opening 64 to selectively close and open the opening 64.

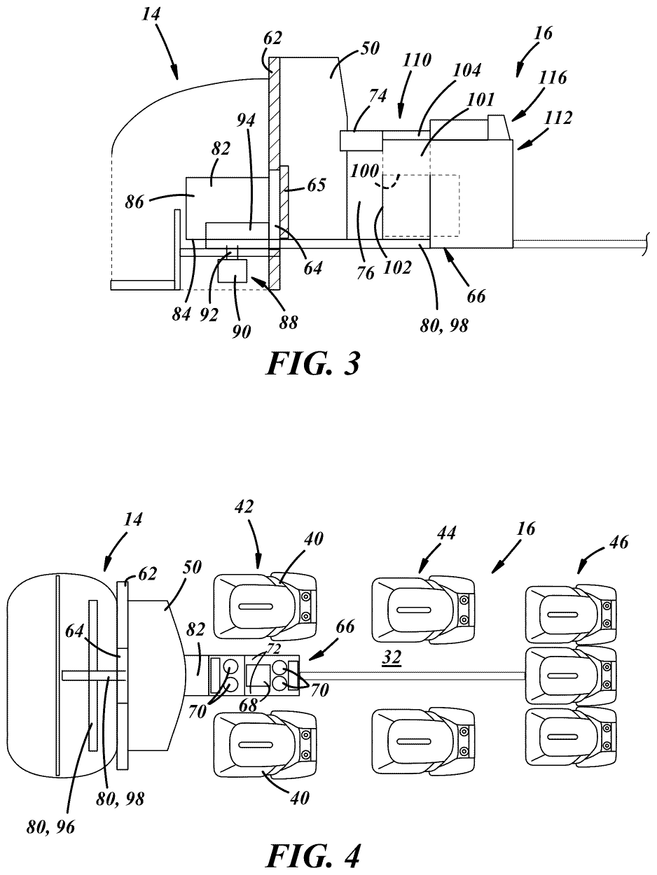

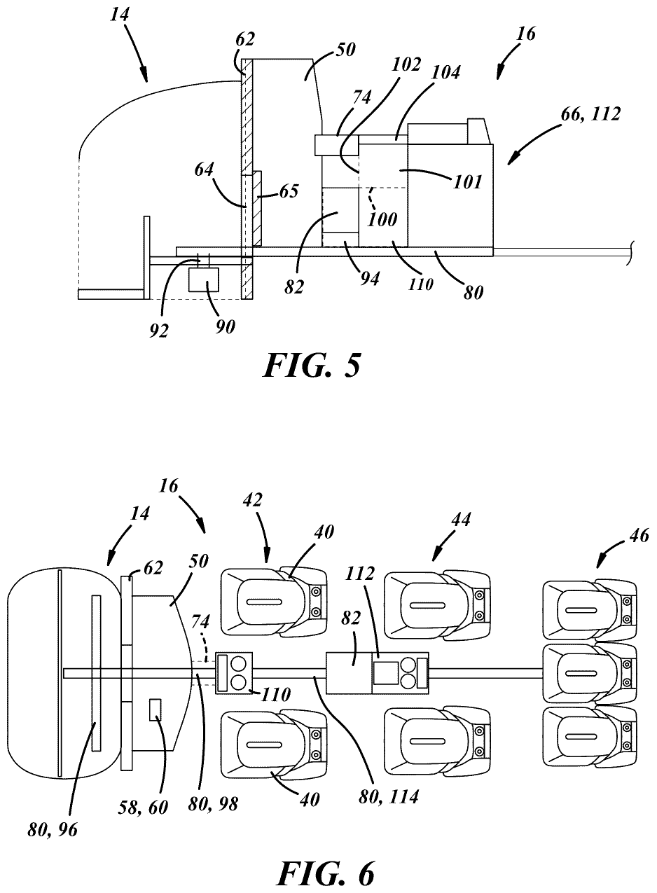

The vehicle 10 may include a console 66 that may, for example, have one or more storage compartments 68, one or more cupholders 70, an armrest 72 and other features or components as desired. The console 66 may be located between two seats 40, such as between the front two seats, as shown in FIGS. 2-5. In this arrangement, the console 66 may be generally centered in the cross-car direction and may be spaced from the instrument panel 50 in the fore-aft direction. The console 66 could be part of the instrument panel 50, or it may be coupled thereto by a bridge 74, such as is shown in FIGS. 3 and 5. The bridge 74 may provide some of the features noted (e.g. cupholders or storage areas) and may be spaced vertically from the floor 40 and arranged near an upper portion of the console 66. A space 76 (FIG. 3) may be provided between a lower surface of the bridge 74 and the floor 40, and things may be stowed in the space. Sidewalls or the like may be provided to contain items and keep the items out of footwells in front of the seats 40.

To contain stowed items and to facilitate moving items between the cargo compartment 14 and the passenger compartment 16, the vehicle 10 may include a container path 79 that extends through the opening and between the cargo compartment 14 and at least partly into the passenger compartment 14. A track 80 may be provided along at least part of the path 79, and the track 80 may extend through the opening 64 and has part located in the cargo compartment 14 and/or part in the passenger compartment 16. The track 80 may be of any suitable construction and may be continuous or discontinuous along its length which may be oriented in the fore-aft direction. The track 80 may extend into the passenger compartment 16 and to, partly into or adjacent to the console 66. While shown as an elongated and generally flat member received on the floor of the vehicle 10, the track 80 may instead or in addition include sidewalls or guiderails spaced apart in the cross-car direction.

To facilitate transferring things between the cargo compartment 14 and the passenger compartment 16, a container 82 is associated with the track 80 and is movable along the track 80. As shown in FIG. 3, the container 82 has a body which may include a bottom wall 84 and sidewalls 86 extending vertically from the bottom wall 84. The container 82 may be open at its upper end or closed, such as by a removable or movable cover or lid. Items may be placed in and contained by the container 82, and removed thereform, as desired. As shown in FIGS. 2 and 3, the container 82 has a first position in which the container 82 is located within the cargo compartment 14 and, as shown in FIGS. 4 and 5, a second position in which the container 82 is located within the passenger compartment 16. The container 82 may be of any suitable size and shape and is designed to pass through the opening 64 when it moves between the first and second positions, and the container 82 may be stopped between those positions in one or more intermediate positions, as desired.

The container 82 may be manually moved along the track 80 or the container 82 may be coupled to and driven by an actuator 88. In at least some implementations, the actuator 88 includes a motor 90 and a drive member 92 that is driven by the motor. For example, the motor 90 may be fixed in the vehicle 10, such as in the cargo compartment 14 or otherwise in the front compartment 14, and the motor 90 the drive member 92 may be a power transmission member, such as a belt, chain or cable. The belt, chain or cable may be driven by a gear or wheel that is rotated by the motor 90, or otherwise driven, as desired. To move the container 82, the container 82 may be coupled to the drive member 92 for movement as the drive member 92 moves. In at least some implementations, as shown in FIGS. 3 and 5, a shuttle or carrier 94 is provided that is coupled to the drive member 92, and the container 82 is connected to the carrier 94 so that both the carrier 94 and container 82 are driven by the motor 90. Other arrangements may be used, as desired. For example, the motor 90 may be carried by the container 82 and may directly rotate wheels coupled to the container 82 to move the container 82 relative to the vehicle 10. The wheels may move along the vehicle floor, or along the track 80, or both.

In at least some implementations, the container 82 may be movable within the cargo compartment 14 such that the container 82 has positions in which the container 82 is not aligned with the opening 64. That is, the container 82 may be offset in the cross-car direction, for example, from the opening 64. To facilitate such movement, as shown in FIGS. 2 and 4, the track 80 may include a second portion 96 that is received in the cargo compartment 14 and which guides and enables movement of the container 82 in the cross-car direction. In the example shown, the second portion 96 is provided at an end of the first portion 98, which extends into the passenger compartment 16. This lateral or cross-car movement of the container 82 can help to move the container 82 out of the center of the cargo compartment 14.

Additionally, the movement in a second direction enables more than one container 82 to be received in the cargo compartment 14, and selectively aligned with and movable through the opening 64, as shown in FIG. 2. In this way, a first container 82 may be moved in the cross-car direction out of the way of the opening 64 and spaced from the end of the first portion 98 of the track 80, to permit a second container 82 to be aligned with the opening 64 and ready for movement along the first portion 98 of the track 80 (e.g. into the passenger compartment 16). The second portion 96 of the track 80 may accommodate movement of a container 82 in one or both directions away from the opening 64 (e.g. toward the right and/or left sides of the vehicle 10). A separate actuator may be provided to move the containers 82 in the cross-car direction. The containers 82 may be moved along the second portion 96 on a carrier or shuttle 94, which may be arranged for movement along both the second portion 96 and the first portion 98 of the track 80, in a least some implementations. In this way, each container 82 may be received on a separate carrier or shuttle 94. The containers 82 may be releasable from the carriers or shuttles 94 and track 80 to permit the containers 82 to be removed from the vehicle 10, if desired.

To facilitate loading the containers 82 from within the passenger compartment 16 or retrieving items from the containers 82 from within the passenger compartment 16, in at least some implementations, the container 82 meshes or cooperates with the console 66. In the embodiment shown, and with reference to FIGS. 3 and 5, the console 66 includes a void 100 in a forward most or forward-facing side 102 of the console 66. When the container 82 is in the second position, the container 82 is received at least partially in the void 100. The container 82 may define part or all of a storage compartment of the console 66, and it may be accessed by opening a lid or cover 104 on the console 66 that overlies a console opening 101 or chamber leading to the void 100.

In at least some embodiments, the container 82 may be moved to the second position while the vehicle 10 is in use, to permit items to be stored in and retrieved from the console 66. This may occur automatically, if desired, when the vehicle 10 is turned on or otherwise set for use. Additionally, when the vehicle 10 is turned off or otherwise set for non-use, the container 82 may be moved into the cargo compartment 14 so that the container 82 and the contents therein are not accessible from within the passenger compartment 16. This may also be done automatically, if desired. Or this may be done as commanded by a user (e.g. via the HMI). This may be desirable to deter thieves from breaking into the passenger compartment 16 in search of items left in the passenger compartment 16.

In this regard, the cover 65 for the opening 64 may be closed other than when the container 82 is moving therethrough. The cover 65 may be opened manually, or automatically by an actuator. Proximity switches or sensors 106 (FIG. 2), for example, may be used to control movement of the cover 65 to permit a container 82 to pass through the opening 64 and to close the opening 64 after a container 82 moves through the opening 64. The cover 65 could be mechanically driven by movement of the container 82 relative thereto, if desired. By way of a non-limiting example, the container 82 may as it moves near the cover 65 displace a lever or cam that causes movement of the cover 65, and the system may be spring loaded to return to a starting position after such movement. Of course, other arrangements may be used, as desired. This may desirable for security reasons as well as for noise and environment isolation from the passenger compartment 16.

Further, the cargo compartment 14 may be fully enclosed or lockable such that opening the deck lid does not provide direct access to the cargo compartment 14 and containers 82. In this way, items may be stored securely when the vehicle 10 is not in use, or if the vehicle 10 is to be used by another person, for example without limitation, a valet who may drive the car to park it. Prior to giving the vehicle 10 to the valet (or other person), the container 82 may be moved into the cargo compartment 14. Further, the system can be set up to prevent others from commanding the container(s) 82 to move out of the cargo compartment 14, for example, by a lock/key or password/secure identification (e.g. fingerprint reader) type arrangement.

In addition to or instead of having a storage container 82 that is movable between the cargo compartment 14 and the passenger compartment 16, at least part of the console 66 may be movable within the passenger compartment 16, as generally shown in FIGS. 6-8. In the example shown, the console 66 includes a first portion 110 that may be fixed and not movable, and a second portion 112 that is movable relative to the first portion 110.

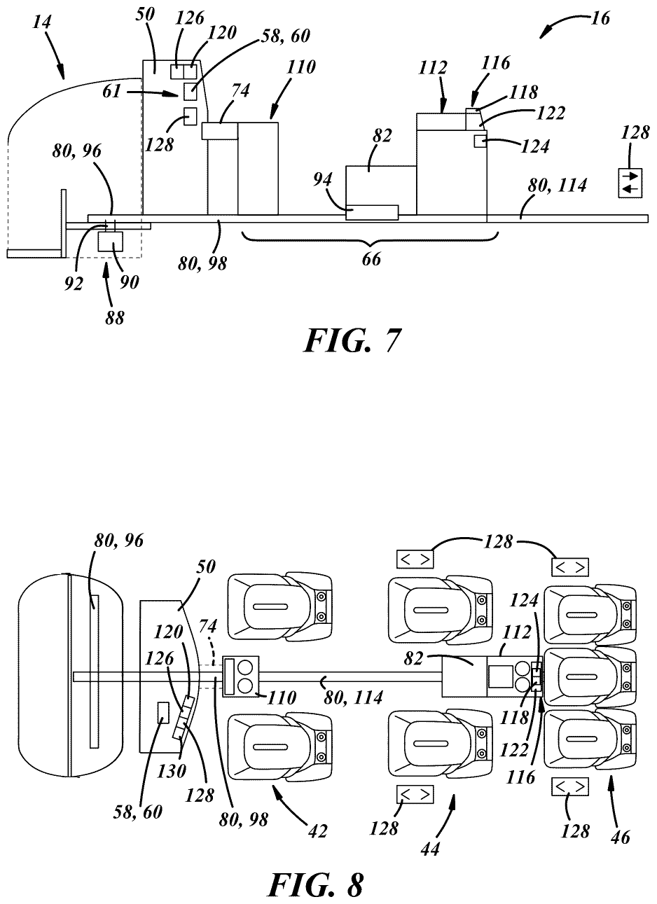

In at least some implementations, the void 100 in the console 66 is a passage through the first portion 110 of the console 66. The container 82 can then pass through the first portion 110 of the console 66, and can be connected to or otherwise movable with the second portion 112 of the console 66. Even without the container 82, the console 66, such as the second portion 112 thereof, can move relative to the front row of seats, in the fore-aft direction. In this way, the container 82 may be selectively coupled to the console 66, such as by an electromechanical latch, movable hook or the like. As shown in FIGS. 6 and 7, the console 66, with or without the container 82, can move to or toward the second row 44 of seats 40 for use of the console 66 by occupants in the second row 44. At least part of the second portion 112 of the console 66 may be overlapped, in the fore-aft direction, with the seats 40 in the second row 44. As shown in FIG. 8, in at least some implementations, the console 66 can move to a position in front of the third row 46 of seats 40, again, with or without the container 82. In this position, some or all of the second portion 112 of the console 66 may be located between the second row 44 and third row 46 of seats, in the fore-aft direction.

In the example shown, the track 80 includes a third portion 114 that extends beyond the console 66 in the fore-aft direction, and between the second row 44 of seats and to or toward the third row 46 of seats. The third portion 114 may be an extension of and contiguous with the first portion 98 of the track 80, if desired. In this way, the drive member 92 of the actuator 88, at least when an elongated member such as a belt, rotatable or stationary screw (e.g. along which the shuttle travels without rotation about the screw), chain or cable, can extend along at least part of the third portion 114 of the track 80. The second portion 112 of the console 66 can be selectively connectable to the drive member 92 and moved along the track 80 when so connected and when the drive member 92 is driven by the motor 90. In other implementations, a motor may be associated with the second portion 112 of the console 66, and may drive rotary components, like wheels, sprockets (e.g. with projections that engage spaced holes in the track) or the like, to move the console 66 along the third portion 114 of the track 80.

The movable console 66/112 permits many functions. For example, a person in one row of seats can place items on the console 66 for delivery to a person in another row. The console 66 can provide cupholders 70 and storage bins 68 within reach of passengers in the various rows 42, 44, 46 of seats 40. Further, if the console 66 includes a HMI 116, for example, to control in-vehicle displays, movies, gaming or the like), heating and cooling (e.g. for rows other than the front row of seats) or audio equipment, moving the console 66 can permit passengers in different rows to have access to such HMI controls 116. Further, if the container 82 moves with the console 66, then passengers in the second or third row 44 or 46 of seats can have access to the container 82 and can take items out of or place items in the container 82 for delivery to a passenger in a different row of seats, or into the cargo compartment 14, if a container 82 is also available. To facilitate passenger ingress and egress from the vehicle 10, the second portion 112 of the console 66 can be moved to its first position, adjacent to the front row 42 of seats, as desired.

In at least some implementations, as shown in FIGS. 7 and 8, a video output device 118, e.g. a camera, may be provided on the movable console 66 and the camera 118 may provide a video feed to a display 58 on the instrument panel 50, for example. This may enable a person in the front row 42 of seats to see at least part of the passenger compartment 16 that is behind them, without having to turn around. In one example, the camera field of view may include the seats 40 in the second row 44 and/or third row 46, and in particular, a child's seat, to enable a driver or other front row passenger to monitor a child in that seat. For two-way viewing, another video device/camera 120 may be provided with a field of view including the front row 42 of seats, and in particular, a driver's seat. The console 66 may include a display 122 and one or both cameras 118, 120 may provide a video feed to the display 122 (as well as to the instrument panel display 58 or other display in the vehicle). Audio devices 124, 126 may have inputs and outputs (e.g. microphones and speakers) and may also or instead of the cameras be provided at both of the console 66 and instrument panel 50 (or other location accessible by front row passenger(s)) to facilitate two-way audible communication between passengers in different rows of seats. In this way, the movable console 66 may include video and/or audio devices that enable a video and/or audio interface with passengers in different rows of seats.

Suitable controls 128 to cause movement of the console 66 (e.g. forward and backward buttons or inputs) may be provided in one or more desired locations within the passenger compartment 16. The controls 128 may provided near the front row 42 of seats, for example on the instrument panel 50, or on the first portion 110 of the console 66, to enable control of the location of the console 66 by a passenger in the front row 42 of seats. Additional controls 128 may be provided near the seats in the other rows 44, 46 of seats, if desired, so passengers in those seats can command movement of the console 66. In such implementations, it may be desirable to have an override switch 130 located for access by passengers in the front row 42 of seats so that a passenger in the front row can prevent passengers in the second or third rows 44, 46 from moving the console 66 when such movement is not desired.

In addition to user commanded motion of the console 66, some movement of the console 66 may occur automatically, if desired. For example, when the console 66 is not in the first position, the system may actuate the motor to return the console 66 to the first position, for example, when the vehicle is powered off. This may move the console 66 out of an aisle between the second and/or third row 44, 46 of seats, and facilitate passenger ingress and egress from the vehicle 10.

The systems provide a unique storage solution that enables easy transfer of things between a passenger compartment 16 and a cargo/storage compartment 14, and/or transfer of things between passengers in different rows of the vehicle. This may facilitate having more things accessible within the vehicle, such as with multiple containers that may be selectively brought into the passenger compartment 16 from the cargo compartment. Increased security is also achievable by enabling stored items to be removed from the passenger compartment 16 and located in a secure area outside of the passenger compartment 16 when not needed, or when the vehicle is parked or might be driven by another person. In at least some implementations, the console 66 may be used to store items that are more frequently used or needed in use of the vehicle, and the cargo compartment may be used to store items less frequently needed or used, and to securely store things when the vehicle is not in use, or is in a valet or similar mode. Further, the movable console 66 can include video and/or audio devices to facilitate communication by passengers in different rows within the passenger compartment 16.

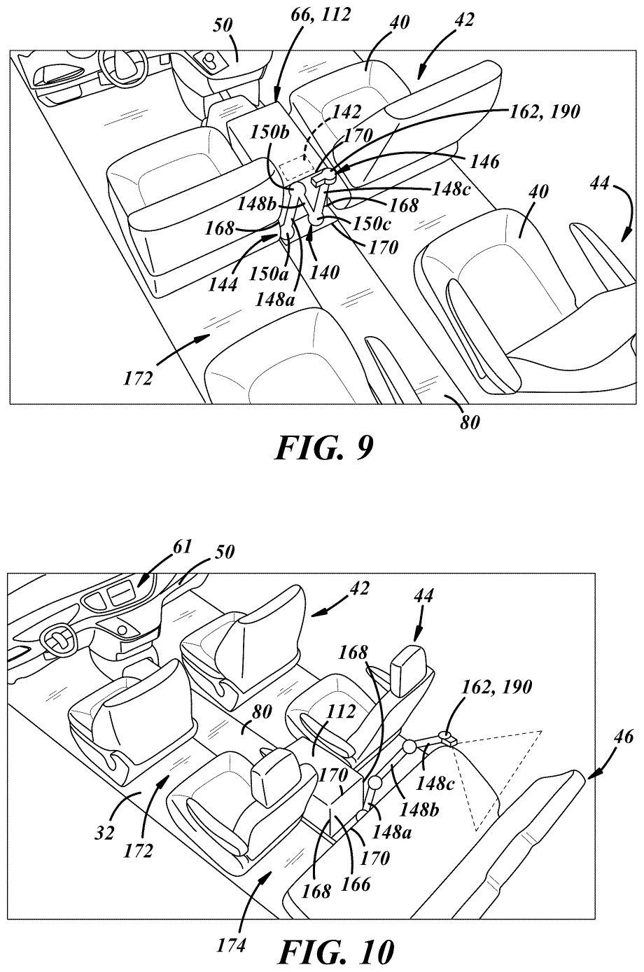

As shown in FIGS. 9-13, the console 66 can include a robotic arm 140 to further increase the areas within the passenger compartment 16 that may be accessed or interacted with by the movable portion 112 of the console 66. The movable portion 112 of the console 66 (for ease of reference this will sometimes simply be called the console 112, as above) may move along the track 80 and relative to the rows 42, 44, 46 of seats 40, with or without a container 82, as noted herein. Further, the robotic arm 140 is coupled to the movable console 112 so that the arm 140 moves along with the console 112 to different parts of the vehicle interior, as noted.

To move the robotic arm 140 relative to the console 112, the robotic arm 140 includes or is coupled to one or more actuators 142, which may include one or more motors and drive members (e.g. links, gears, drive shafts, or the like). In this regard, the arm 140 is coupled to the console 112 at a base or first end 144, and has a second end 146 that is not connected to the console 112. The arm 140 may comprise multiple segments or links 148 each connected together at a connection point or joint 150. The joints 150 permit desired movement of the segments/links 148 relative to each other, and may be defined by hinges, ball and socket joints, other rotary joints, or other suitable connections to provide desired degrees of freedom, axes of rotation and range of motion for the arm 140. In the example shown in FIG. 9, the arm 140 includes three sections or links 148 with the first end of a first link 148a connected to the console 112 at a first joint 150, a second end of the first link 148a connected to the first end of a second link 148b at a second joint 150, and the second end of the second link 148b connected to a first end of a third link 148c at a third joint 150c. An end effector 162 is provided at the second end 146 of the arm 140.

The links 148a-c may move relative to each other and the console 112 at the joints 150a-c, and may be folded to a first position as shown in FIG. 9, and extended to multiple other positions, as shown in FIGS. 10-13, to position the end effector 162 in a desired location, and/or permit a desired utility or function of the end effector 162 in a desired location. In the first position, the arm 140 may be received within the boundaries or periphery of an adjacent side or surface 166 of the console 112. In the example shown, the arm 140 is connected to a rear surface 166 of the console 112, although the arm 140 could be connected to the top, front or left or right sides of the console 112, if desired. In the example shown, and in the first position of the arm 140, shown in FIG. 9, the arm 140 is received between opposite side edges 168 that extend vertically, and opposite upper and lower edges 170 of the rear surface of the console 112, that extend in the cross-car direction. In at least some implementations, the arm 140 may be folded so that a cross-car dimension is less than the cross-car dimension of the console 112 (e.g. the distance between the side edges 168), or a space between the seats 40 in one or both of the first row 42 and second row 44. Further, if desired, the arm 140 when folded may have a vertical dimension that is less than the vertical dimension of the console 112 (e.g. the distance between the upper and lower edges 170). In this way, the arm 140 is out of the way from the seats 40 adjacent to the track 80 when the console 112 moves along the track 80, so that the arm 140 does not interfere with movement of the console 112 along the track 80. In at least some implementations, a command to move the console 112 along the track 80 first retracts or folds the arm 140 to its first position before the console 112 moves along the track 80, to ensure the arm 140 will not engage a seat 40 and interfere with movement of the console 112.

When positioned on or near the rear surface, the arm 140 is situated near an aisle or open area 172 between the first row 42 of seats 40 and the second row 44 of seats 40 when the console 112 is in the first position, and the arm 140 can be positioned near or in a second open area 174 between the second row 44 and third row 46 of seats 40 when the console 112 is moved sufficient toward the rear of the vehicle, and when in the second position. In this way, the arm 140 can be moved within the first and second open areas 172, 174, in the cross-car direction away from the console 112, and vertically toward or to the floor 32 and to or at least partly toward the roof 30, to perform different functions as set forth later. While a single arm 140 is shown in the embodiments included in the drawings, multiple arms 140 may be connected to the console 112 and may move with the console 112 as the console moves.

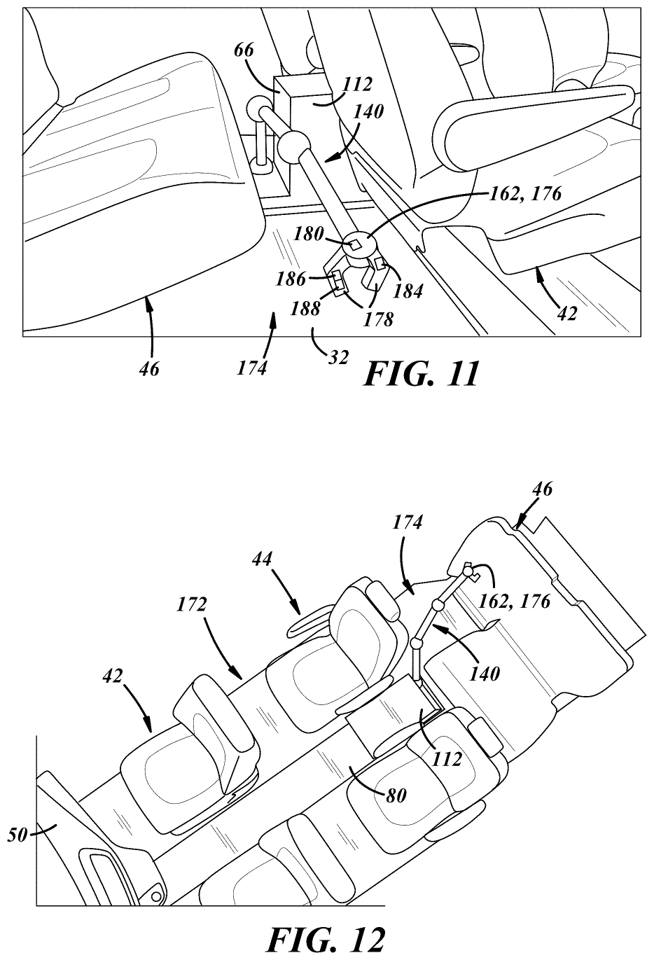

As shown in FIGS. 11-13, the end effector 162 may be or include a gripper 176 to grab, hold and move objects. The gripper 176 may include movable segments (e.g. fingers 178), and/or a tool or tool attachment for a vacuum or other suction/gripping feature, a magnetic feature, or other, as desired. The end effector 162 could include a light 184 to facilitate directing light into desired portions of the passenger compartment 16. The end effector 162 could also include one or more sensors 186 to detect objects to be interacted with by the end effector 162 (e.g. a gripper 176) or to permit automated movement of the arm 140 without or with limited engagement with the seats 40 and other things in the passenger compartment 16. The sensor(s) 186 could be proximity sensors, could include vision sensors like a camera, radar, lidar, ultrasonic or other, could be light sensitive or responsive and could determine distances to objects. Beyond a gripper 176, the end effector 162 could also be or include one or more tools 188, like a vacuum attachment by which surfaces of the passenger compartment 16 can be vacuumed, a brush or other tool attachment, or audio and/or video devices (collectively referred to at 190), like a camera, microphone and/or speakers, where the arm 140 facilitates moving the audio and video devices to different areas in the passenger compartment 16 for use by people in different locations.

In FIG. 9, the arm 140 is shown in the first or home position, and is folded against the rear surface of the console 112. The console 112, is also shown in its first position, between the two seats 40 in the front row. With the arm 140 at the rear side 166 of the console 112, the arm 140 can be moved within the area between the first row 42 and second row 44 of seats 40. In at least some implementations, the arm 140 may be articulated and moved so that the end effector 162, at least when it includes a gripper 176, can move things onto and off of the console 112, including into or out of storage areas of the console 112. The end effector 162 could move things from, for example, a vehicle seat 40 or the floor 32 to the console 112, or move things between a person and the console 112.

In FIG. 10, the console 112 is moved to its second position, at the aft end of the track 80, near the third row 46 of seats 40 and with the arm 140 in the area 174 between the second row 44 and third row 46. In this example, the end effector 162 includes a camera 190, which may optionally include or be combined with one or both of an audio input and audio output. The arm 140 is extended toward the right side of the vehicle and in front of the rightmost seat 40 in the third row 46, so that the camera 190 has a field of view that includes the area of this seat 40. As noted earlier, the video and audio from the camera/audio device 190 may be fed to the infotainment system 61 to permit interaction (viewing/talking) between a person in the first row 42 and a person in the third row 46. While shown as a camera 190, the end effector 162 could be or carry a display, and may also include a camera and audio input/output. With the arm 140 extended as shown, a person in the adjacent seat 40 can view the display, and optionally may be on camera and in audio communication via the audio input and output. Of course, the audio and video interface can also be provided for one or more people in the second row 44 of seats 40, and/or for a person in the first row 42, by moving the console 112 and the arm 140 or arms of the console 112, accordingly.

In FIG. 11, the console 112 is shown in the second position and the arm 140 is extended laterally, in the cross-car direction into the area 174 between the second row 44 and third row 46 of seats 40. The arm 140 includes an end effector 162 with a gripper 176 having relatively movable fingers 178 that are driven toward and away from each other by an actuator 180 to enable the end effector 162 to pick up and drop or let go of objects. The end effector 162 may also include one or more components 182 such as sensors 186 (including vision sensors, proximity sensors, etc), lights 184 or other components, to enable the arm 140 to be moved to a desired location and to assist in locating and manipulating objects, by way of non-limiting examples.

In FIG. 12, the console 112 is shown in the second position and the arm 140 is extended toward the third row 46 of seats 40. In this example, the seats 40 of the third row 46 can be moved to different positions, and the arm 140 is adapted to engage the seats 40 and move the seats 40 to the different positions. By way of non-limiting examples, the seats 40 may be moved in a fore-aft direction, the seat back may be folded down toward or onto the seat bottom, the seat bottom/seat 40 can be rotated or pivoted toward the rear of the interior, and the seat 40 can be folded flat down onto the floor 32 or in a compartment in the floor 32. Such seat movements enable users to configure the passenger and cargo/storage areas in the vehicle as they desire. In this example, the arm 140 can be commanded to position the seat or seats 40 as desired, and this can be done before a person enters the vehicle. For example, the arm 140 could be controlled remotely, such as by operation of a software application on a remote device 192 (FIG. 14) such as a phone or computer, with commands communicated wirelessly to a control system 194 and the arm actuator(s) 142. The arm 140 could also be commanded via the infotainment system interface within the vehicle, by way of non-limiting examples. The arm 140 could manipulate latches and levers that permit manual release and lock the seats 40 in different positions, and/or the seats 40 could include motors that move the seats 40 among the different positions and the arm 140 can interact with inputs that control the motors, as desired. In some implementations, the weight and complexity of motorized seats 40 can be avoided by using the arm 140 to change the position of the seats 40. Additionally, some vehicles have other features, like tables, that can be moved to more than one position, and the arm/system can be used to also position passenger compartment 16 features other than seats 40.

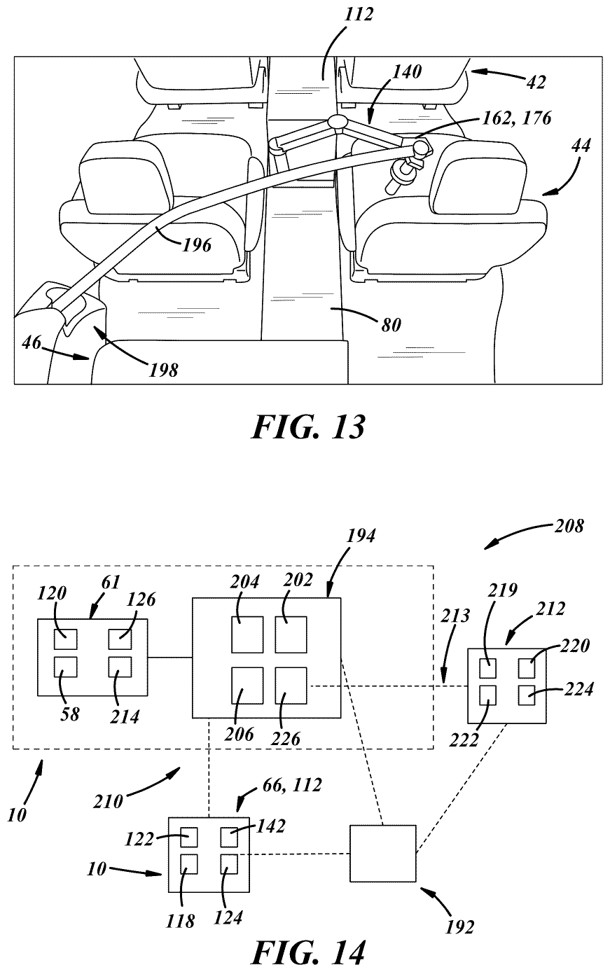

In FIG. 13, the console 112 is shown between the first position and the second position, and the arm 140 is extended toward a seat 40 in the second row 44. The arm 140 includes an end effector 162 that includes a gripper 176, and the gripper 176 is holding an end of a hose 196 of a vacuum 198 in the vehicle. The hose 196 is extendable from a vacuum base, and the console 112 can be moved, and the arm 140 and gripper 176 can be manipulated, to move the hose 196 about the passenger compartment 16 to vacuum areas of the passenger compartment 16. In other implementations, the vacuum 198 may be carried by the console 112, the tube 196 may be routed along the arm 140, and the end effector 162 may include an opening to the tube 196 through which suction can be applied to vacuum areas of the passenger compartment 16. In this way, the vacuum feature is readily available to the arm 140 and the console 112, without having to move the console 112 and arm 140 to a particular location of a vacuum 198.

As noted, one or multiple robotic arms 140 are attached to a movable console 112, providing the ability to move the arm(s) 140 about the passenger compartment 16 and perform a wide range of tasks. The arm(s) 140 may be movable about three axes, and relative to the console 112 in the vertical, cross-car and fore-aft directions, as desired. In two and three-row passenger vehicles, the console 112 and arm(s) 140 enable interaction with people and things in different areas of the vehicle. Objects, like a vacuum, items left in the vehicle, seats 40 and the like can be detected and/or manipulated remotely, with or without occupants present in the vehicle. In vehicles having an interior with components that can be re-configured for multiple use cases, and users can benefit from the vehicle interior being pre-configured for a desired use case before they begin a journey.

Additionally, the movable console 112 and arm(s) 140 provide an ability to autonomously search for and detect items on the floor or seats 40 of a vehicle through sensors on the robotic arm 140. This can be useful, by way of a non-limiting example, when the vehicle is occupied and a child drops a toy, food item, or other object on the floor, as well as when the vehicle is not occupied and an item is missing and the vehicle needs to be searched. The system may provide an output to a user, such as an image or video feed by which a user can see (e.g. through a mobile device application) different areas of the passenger compartment 16, and the user may control the movement and field of view of a camera by moving the console 112 and/or arm 140 even when the user is not within the vehicle. In addition to locating items, the arm 140 can include an end effector 162 capable of picking up and re-locating items onto the console 112 or other locations for easy retrieval by a person later.

With video and/or audio devices, the console 112 and arm 140 enable real-time, face-to-face interactions between occupants in different rows of seats 40, without the need for occupants to turn around. This includes, by way of a non-limiting example, the ability for front row occupants to visually monitor occupants in a rear-facing child seat.

The console 112 may include arms 140 having different capabilities to increase the utility of the system. For example, the console 112 may include a light duty arm with object detection and video/audio capability, and also a heavier duty arm with sufficient size, and power to move larger objects around in the passenger compartment 16, especially when the vehicle is unoccupied.

During regular use of a vehicle, objects tend to be dropped on the floor or lost in a space underneath seats 40 or in out of reach corners of the vehicle interior. During a journey, the driver or other occupant of a vehicle may want to know where an object is located if it has fallen to the ground or is otherwise out of view. When not in a vehicle, a user may find it necessary to perform a visual search of a vehicle interior for lost or misplaced items. Having a camera and/or other vision sensor(s) on the arm 140, the vision sensors can be moved about the passenger compartment 16 and this offers a great advantage over cameras that are fixed in place in the vehicle. Further, a single camera on the robot can be moved to many areas of the passenger compartment 16 and provide views of nearly every area of the passenger compartment 16, including on top of seats 40, to or in a space under seats 40 between a seat bottom and the floor 32, in areas between seats 40, and on and in the console 112 and other storage compartments.

Communication between the audio and video devices, as well as communications to and received from a remote source, can be managed by a control system 194 of the vehicle. As shown in FIG. 14, and to perform various functions, the control system 194 includes a processor 202, memory 204 and programming 206 stored in the memory and accessible by the processor. The control system 194 may be arranged to permit wireless access to one or more remote sources, such as by cellular, wi-fi or other connection. The control system 194 may be communicated with a remote device 192 within the vehicle, such as a smart phone, computer or tablet, that is itself wirelessly connected to the one or more remote sources, to enable the control system 194 to access the remote sources via the remote device 192.

The control system 194 may be part of a vehicle communication system 208, such as is shown in FIG. 14. The communication system 208 may include a frontend portion 210 with one or more network vehicles 10 that are in communication with a backend portion 212 via one or more communication devices and suitable communication protocols. The network vehicles may include in-vehicle infotainment (IVI) systems 61 (FIGS. 7, 10 and 14) that utilize a combination of software and hardware components to provide a wide range of information, system controls and entertainment, as is known and noted herein. As diagrammatically shown in FIG. 14, the IVI system may include one or more display screens 58, 122 and a user interface 214. The user interface 214 may include various inputs, like buttons, switches, touch-sensitive areas of the displays 58, 122, audio devices 124, 126 (microphone(s) for audio or voice commands and inputs, and speakers), and the like.

With reference to FIGS. 9-11, the vehicle communication system 208 may be a cloud-based system that may receive incoming information from individual ones of the network vehicles 10 and send outgoing information to one or multiple network vehicles 10, where the outgoing information may include mass communications (i.e. notifications) that are the same for multiple vehicles or individual communications that are each specific to the vehicle to which each individual communication is sent.

The term “real-time”, as used herein, does not strictly require that such information and notifications be generated, sent, received and/or otherwise processed at the exact moment when their underlying events or conditions occur in order to be “real-time”. Rather, these terms broadly include any such information and notifications that are generally contemporaneous with their underlying events or conditions so that the environmental conditions information and notifications are still relevant or accurate in the context of the present system and method (e.g., within seconds, minutes or even hours of their underlying events or conditions). Further, information may be sent from or a vehicle as during use of the vehicle, or before or after use of the vehicle.

System 208 may deliver hosted services via the internet and/or other communication networks and may be structured as a public, private or hybrid cloud, for example. According to one non-limiting example, vehicle communication system 208 is structured as a private cloud and generally includes the backend portion 212 and the frontend portion 210 that is distributed across a fleet of network vehicles 10, where each network vehicle 10 is capable of obtaining and providing information as well as communicating with the backend portion 212 over a secure communications network 213 (e.g., secure vehicle-to-cloud (V2C) network), and/or communicating with other vehicles via a vehicle-to-vehicle (V2V) connection. The secure communications network 213 may include a cellular-based network, a satellite-based network, a city-wide WiFi-based network, some other type of communications network and/or a combination thereof.

Backend portion 212 may include any suitable combination of software and/or hardware resources typically found in a backend of a cloud-based system, as best illustrated in FIG. 1. The backend portion 212 may be responsible for managing some of the programs and algorithms that run applications on the frontend portion 210, such as those that permit remote interfacing or control of the console 112 and arm(s) 140. The backend portion 212 may be managed or controlled by the vehicle manufacturer and can be part of a larger cloud-based system that the vehicle manufacturer uses to communicate and interact with a large fleet of vehicles for a multitude of purposes. For example, the backend portion 212 may include or communicate with emergency alert systems, such as those that provide Amber alerts or other missing persons alerts, or law enforcement systems that may provide and receive information regarding vehicles of interest to them. The backend portion 212 may also execute programs and instructions to enable use of the application that may be used to remotely control the console 112 and arm 140 from a remote device 192.

The backend portion 212 may include any suitable combination of software and/or hardware resources including, but not limited to, components, devices, computers, modules and/or systems such as those directed to applications, service, storage, management and/or security (each of these resources is referred to herein as a “backend resource,” which broadly includes any such resource located at the backend portion 212). In one example, the backend portion 212 has a number of backend resources including data storage systems 219, processors or servers 220, communication systems 222, programs and algorithms 224, as well as other suitable backend resources. It should be appreciated that backend portion 212 is not limited to any particular architecture, infrastructure or combination of elements, and that any suitable backend arrangement may be employed.

Frontend portion 210 may include any suitable combination of software and/or hardware resources typically found in a frontend of a cloud-based system, as shown in FIG. 10, and is generally responsible for sending information to the backend portion and receiving notifications, programs, instructions and the like from the backend portion 212. Depending on the particular arrangement, the frontend portion 210 may also be responsible for gathering camera, sensor, location and/or other data from devices on the vehicle 10, including those associated with the robotic arm 140 as noted herein. The frontend portion 210 is typically responsible for running the applications that interface with the users in the different vehicles 10, and for interfacing with the programs and algorithms 224 of the backend portion 212. The frontend portion 210 may also be managed or controlled by the vehicle manufacturer and can be part of a larger cloud-based system that the vehicle manufacturer uses to communicate and interact with a large fleet of vehicles for various purposes, as mentioned above. The frontend portion 210 may be distributed across one or more vehicles 10 and may include any suitable combination of software and/or hardware resources including, but not limited to, components, devices, computers, modules and/or systems (each of these resources is referred to herein as a “frontend resource,” which broadly includes any such resource located at the frontend portion 210).

In one example, the frontend portion 210 has a number of frontend resources including a vehicle control system 194 having one or more vehicle electronic module(s) installed in vehicles 10, which may include some combination of a data storage unit 204, an electronic control unit and/or processor(s) 202, programming/applications 206, a communications unit 226 (e.g., one that includes a telematics unit and/or other communication devices with a receiver by which information is received at unit 226 and a transmitter by which information is sent from the unit 226), as well as other suitable frontend resources. The control system 194 may be or include a telematics box module (TBM), a telematics control module (TCM), a body control module (BCM), an electronic control unit (ECU), an infotainment control module, or any other suitable module known in the art. It is not necessary for the preceding units to be packaged in a single vehicle electronic module, rather, they could be distributed among multiple vehicle electronic modules, they could be stand-alone units, they could be combined or integrated with other units or devices, or they could be provided according to some other configuration. It should be appreciated that frontend portion 210 is not limited to any particular architecture, infrastructure or combination of elements, and that any suitable frontend arrangement may be employed. The frontend portion 210 may also control the actuators 88, 142 that control movement of the console 112 and movement of the arm 140 as well as receive and process or otherwise control information from sensors or other devices of the end effector 162 or otherwise associated with the arms and console 112.

In order to perform the functions and desired processing set forth herein, as well as the computations therefore, the control system 194 may include, but is not limited to, one or more controller(s), control unit(s), processor(s), computer(s), DSP(s), memory, storage, register(s), timing, interrupt(s), communication interface(s), and input/output signal interfaces, and the like, as well as combinations comprising at least one of the foregoing, as generally described with regard to the frontend portion 210. For example, the control system 194 may include input signal processing and filtering to enable accurate sampling and conversion or acquisitions of such signals from communications interfaces and sensors. As used herein the terms control system 194 may refer to one or more processing circuits such as an application specific integrated circuit (ASIC), an electronic circuit, a processor (shared, dedicated, or group) and memory that executes one or more software or firmware programs, a combinational logic circuit, and/or other suitable components that provide the described functionality. The control system 194 may be distributed among different vehicle modules, such as an infotainment system control module, engine control module or unit, powertrain control module, transmission control module, and the like, if desired, and the memory and one or more processors may be one or both integrated into the vehicle 10 or remotely located and wirelessly communicated to the vehicle 10, as desired.

The term “memory” or “storage” as used herein can include computer readable memory, and may be volatile memory and/or non-volatile memory. Non-volatile memory can include, for example, ROM (read only memory), PROM (programmable read only memory), EPROM (erasable PROM), and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM). The memory can store an operating system and/or instructions executable by a processor or controller or the like to enable control or allocate resources of a computing device.

What is claimed is:

1. A vehicle, comprising:
a passenger compartment including two seats in a front row, the two seats in the front row being spaced apart in a cross-car direction extending between a left side and a right side of the vehicle, and multiple seats in one or more rows spaced from the front row in a fore-aft direction extending between a front and a rear of the vehicle;
a console located in the passenger compartment, at least part of the console being a movable portion that is movable from a first position in which the movable portion is received between the two seats in the front row and a second position in which the movable portion is spaced in the fore-aft direction from the two seats in the front row; and
an arm carried by the console for movement with the console, wherein at least part of the arm is movable relative to the console to permit an end of the arm to be positioned in different locations relative to the console.

2. The vehicle of claim 1 which also includes one or more actuators carried by the console and coupled to the arm to move the arm relative to the console.

3. The vehicle of claim 1 wherein the arm includes an end effector that includes one or more of a video device, a display, an audio device, a proximity sensor, a distance sensor, a light, a vison sensor, a tool attachment, and a gripper.

4. The vehicle of claim 3 wherein the end effector includes a first video device and images captured by the first video device are sent to a second video device that is arranged for use by a passenger in the front row

5. The vehicle of claim 3 which also includes a control system communicated with the console and the arm, and wherein the end effector includes a first video device communicated with the control system for wireless transmission from the vehicle.

6. The vehicle of claim 1 wherein the arm is defined by multiple segments with a separate joint connecting each segment of the multiple segments to an adjacent segment of the multiple segments, and wherein the joints permit movement of the segments relative to each other and relative to the console.

7. The vehicle of claim 6 wherein the arm includes an end effector that is provided on a free end of an end segment of the multiple segments, and the end segment is connected to a different segment of the multiple segments at a location spaced from the free end, and wherein the end effector is movable relative to the console about three axes.

8. The vehicle of claim 6 wherein the arm is connected to the console at a first end of a first segment of the multiple segments, and the arm has a free end at an end of a different segment of the multiple segments and an end effector is provided at the free end to permit the end effector to be moved relative to the console.

9. The vehicle of claim 8 wherein the first end is connected to a surface of the console and the surface includes a periphery defined by edges of the surface, and wherein the arm has a first position in which the arm does not extend outwardly of the periphery of the surface.

10. The vehicle of claim 9 wherein the surface is a rear surface of the console that has opposite side edges that extend in a vertical direction, and opposite upper and lower edges that extend in the cross-car direction, and when the arm is in the first position of the arm the arm does not extend in the cross-car direction beyond the side edges and the arm does not extend in the vertical direction beyond the upper edge or lower edge.

11. The vehicle of claim 2 which includes a control system communicated with the console and the actuator, the control system including a communication device by which instructions for control of the arm can be wirelessly received and communicated with the control system to activate the actuator and control the arm in accordance with the instructions.

12. The vehicle of claim 3 wherein the end effector includes a camera and the arm is extendable to move the camera away from the console and toward a seat that is not within the front row and which is at least partially offset in the cross-car direction from the console.

13. The vehicle of claim 1 which also includes a track located in the passenger compartment and extending in the fore-aft direction, and wherein the movable portion of the console is connected to the track and moves in the fore-aft direction along the track.

14. The vehicle of claim 1 wherein the one or more rows includes a second row of seats that has two seats that are spaced apart in the cross-car direction, and wherein the movable portion of the console is movable to a location in which the movable portion overlaps the seats in the second row in the fore-aft direction.

15. The vehicle of claim 14 wherein the one or more rows includes a third row of seats that has one or more seats spaced in the fore-aft direction from the seats of the second row, and wherein, when the movable portion of the console is in the second position, the arm is located to be able to be moved within a space between the second row and the third row.

16. The vehicle of claim 3 wherein the end effector includes a gripper and the arm is movable to a position in which the gripper can grab an item off of the console or place an item on the console.

17. The vehicle of claim 3 wherein the end effector includes a gripper and wherein the vehicle includes a vacuum and the arm is capable of moving the gripper into engagement with an end of a vacuum hose so that the arm can move the end of the vacuum hose within the passenger compartment to vacuum part of the passenger compartment.

18. The vehicle of claim 1 wherein at least one seat is movable from a first position to a second position and wherein the arm is operable to engage and move the at least one seat from the first position to the second position.

19. The vehicle of claim 1 wherein at least one seat includes an area between a seat bottom and a floor of the passenger compartment, and wherein part of the arm is movable into the area between the seat bottom and the floor.
